(19) United States
(12) Patent Application Publication
(10) Pub. No.: US 2007/0139984 A1
(43) Pub. Date: Jun. 21, 2007

(54) Resonant conversion control method and device with a very low standby power consumption

(76) Inventor: Yu-Kang Lo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/311,244

(22) Filed: Dec. 20, 2005

(51) Int. Cl. H02M 7/04

(52) U.S. Cl. 363/89

(57) ABSTRACT

A resonant conversion control device with a very low standby power consumption has an AC-to-DC conversion unit, a DC-to-DC conversion unit, a DC-to-DC conversion control unit, and a standby mode control unit. The resonant conversion control device effectively makes use of the low switching loss characteristic of a resonant conversion device, and uses the output voltage for judgement of the system operation mode. The resonant conversion control device can control the action statuses of the AC-to-DC conversion unit and the DC-to-DC conversion unit to lower effectively the power consumption under the standby mode. Therefore, the resonant conversion control device can solve the problem of a higher standby power consumption of conventional switching power supplies and meet the requirements of future standby power standards.

### BACKGROUND OF THE INVENTION

1. Field of the invention

The present invention relates to a conversion control method and device with a very low standby power consumption and, more particularly, to a conversion control method and device capable of achieving a higher conversion efficiency and a very low standby power consumption under any load conditions.

2. Description of Related Art

Owing to gradual exhaustion of usable energy, the exploitation of various kinds of energies and restriction of energy use are now becoming a common consensus worldwide. Well-developed countries like the US, Europe, and Japan have made appropriate energy policies for energy use. The standards of power consumption in the standby mode (i.e., green power) of electrical products are generally set below 0.5-1 watt to avoid excessive power consumption when electrical products are standing by. Manufacturers of relevant electronic products have developed appropriate products (power-saving ICs, special-function control ICs, power supplies and so on) for future probable system standards and goods specifications. Existent low standby power consumption switching power supplies and relevant controllers thereof will be described below.

As shown in FIG. 1, an AC-to-DC conversion unit 10 and a DC-to-DC conversion unit 11 are series connected. The AC-to-DC conversion unit 10 is used to convert an AC input voltage V_{ac1} to a first DC voltage V_{dc 11}. The DC-to-DC conversion unit 11 converts the first DC voltage V_{dc11} output by the AC-to-DC conversion unit 10 to a second DC voltage V_{dc12} of 3.3V, 5V, 12V, 24V, 48V, or a voltage value of another specification.

The DC-to-DC conversion unit 11 can adopt an isolated converter architecture or a non-isolated converter architecture. In existent switching power supplies, the flyback converter has been widely used due to the simple architecture and low cost thereof. In addition to controllers (functions) used under normal load conditions, existent flyback converters widely used in the DC-to-DC converter architecture additionally make use a burst mode for control in the standby mode under the demand of green power specifications.

As shown in FIG. 2, in addition to adjusting the duty cycle to minimum, the rear DC-to-DC conversion unit 11 in a conventional power supply with a low standby power consumption intermittently controls the on and off actions of a power transistor by means of a burst mode under a light load or no load. In general, the DC output voltage V_{dc12} can be kept within a certain range (i.e., between an output voltage upper limit V_{B21}, and an output voltage lower limit V_{B22}) in some periods under light load or no load. When the output voltage V_{dc12} is higher than the output voltage upper limit V_{B21}, the system closes a control signal of the power transistor. Until the DC output voltage V_{dc12} becomes lower than the output voltage lower limit V_{B22}, the system outputs the control signal of the power transistor again. In this way, the number of times the power transistor is switched in a period and the system switching loss can be reduced under light load or no load.

The flyback converter needs to use additionally a snubber to reduce the voltage-spike caused by oscillation of leakage inductance and parasite capacitance. Power consumption also accompanies use of the snubber. Moreover, a common flyback converter cannot accomplish soft-switching without using special control or auxiliary switches. Power consumption also accompanies hard-switching of the power transistor. Under the conventional architecture, the system power consumption in the standby mode is about 0.8-1 watt.

### SUMMARY OF THE INVENTION

An object of the present invention is to provide a resonant conversion control method and device with a very low standby power consumption to enhance the conversion efficiency and solve the standby power consumption problem of conventional switching power supplies.

To achieve the above object, the present invention adjusts the switching frequency according to the frequency response and load condition of resonant components in a resonant conversion device to regulate and stabilize the output voltage, and makes use of the energy conversion characteristic of the resonant conversion device to accomplish easily zero-voltage switching, hence achieving a higher converter efficiency. Under the condition of a large load current output specification, a synchronous rectifying circuit is adopted to enhance the whole conversion efficiency. Moreover, a hysteresis comparison control is adopted to control the actions of the resonant conversion device at the appropriate time (generally under a very light load or no load), thereby achieving a very low power consumption in the standby mode.

The resonant conversion control device with a very low standby power consumption of the present invention comprises an AC-to-DC conversion unit, a DC-to-DC conversion unit, a DC-to-DC conversion control unit, and a standby mode control unit. Depending on the system and specification requirements, the AC-to-DC conversion unit can use a power factor corrector (PFC) or a voltage doubler rectifier. In order to meet the requirement for a large load current, a synchronous rectifying circuit can be used in the DC-to-DC conversion unit. The PFC or the voltage doubler rectifier is used for AC-to-DC power conversion. The PFC has functions for power factor correction and voltage regulation of a pre-regulator so as to output a stable first DC voltage. The voltage doubler rectifier can meet the requirement for the system input voltage through automatic or manual switching.

The DC-to-DC conversion unit is used to convert the first DC voltage to a required second DC voltage. The DC-to-DC conversion unit adjusts the switching frequency to regulate and stabilize the second DC voltage based on the load situation. A diode or a synchronous rectifying circuit can be used as the output rectifier of the DC-to-DC conversion unit. The DC-to-DC conversion control unit receives a feedback signal of the output voltage of the DC-to-DC conversion unit to adjust the frequency of a control signal of a power transistor of the DC-to-DC conversion unit, thereby stabilizing the system output voltage. The DC-to-DC conversion control unit can also provide a control signal for a synchronous rectifying power transistor when a synchronous rectifying circuit is used in the DC-to-DC conversion unit.

The standby mode control unit receives the second DC voltage output by the DC-to-DC conversion unit, and respectively outputs a control signal fed back to a PFC controller and the DC-to-DC conversion control unit after determining the present load situation, thereby controlling the circuit actions of the PFC and the DC-to-DC conversion unit. If the AC-to-DC conversion unit is the voltage doubler rectifier, the standby mode control unit only outputs a control signal to the DC-to-DC conversion control unit. The DC-to-DC conversion unit can be a resonant converter.

The system operation of a resonant conversion control method with a very low standby power consumption of the present invention is based on the detection of the output voltage. Three voltage thresholds are used to determine the present system load situation. These three voltage thresholds include a first threshold, a second threshold, and a third threshold. The first threshold is larger than the second threshold, and the second threshold is larger than the third threshold. The system operation is divided into four modes described below according to these three thresholds.

If the voltage level of the second DC voltage is in a hysteresis voltage range between the first and second thresholds, the second DC voltage is a normal and stable voltage. Its value is a system specified rated voltage value. The PFC, the voltage doubler rectifier, and the DC-to-DC conversion unit all operate normally.

If the second DC voltage is outside the hysteresis voltage range between the first and second thresholds, the following steps are performed:
(1) Whether the second DC voltage exceeds the first threshold is first determined. If the answer is yes, the operation of the PFC and the DC-to-DC conversion unit stops. At this time, the lowest value of the first DC voltage is still larger than the rectified voltage value of the mains supply, and its maximum value is the stable first DC voltage value under normal operation.
(2) If the second DC voltage is lower than the second threshold, normal operation of the DC-to-DC conversion unit is resumed, and the operation of the PFC still stops.
(3) After the DC-to-DC conversion unit resumes operation, if the detected second voltage is still lower than the second threshold and is also lower than the third threshold, normal operations of the PFC and the DC-to-DC conversion unit are resumed.

The resonant conversion control method and device with a very low standby power consumption of the present invention can effectively reduce the switching power loss under normal operation. Moreover, the action statuses of the PFC and the DC-to-DC conversion unit can be controlled under different load and voltage conditions, hence effectively lowering the standby power consumption. Furthermore, as compared with the prior art, it is not necessary to use an extra snubber. Under a light load and no load condition, because the system operates at high frequencies, the core power loss is much smaller than that in the prior art. The system power consumption in the standby mode can thus be reduced.

### BRIEF DESCRIPTION OF THE DRAWINGS

The various objects and advantages of the present invention will be more readily understood from the following detailed description when read in conjunction with the appended drawing, in which:

FIG. 1 is a circuit architecture diagram of a conventional switching power supply with a low standby power consumption;

FIG. 2 is a diagram showing the control timing and output voltage in the standby mode in the prior art;

FIG. 3 is an architecture diagram of a resonant conversion control device with a very low standby power consumption of the present invention;

FIG. 3A is a block diagram of a resonant conversion control device with a very low standby power consumption according to a first embodiment of the present invention;

FIG. 3B is a block diagram of a resonant conversion control device with a very low standby power consumption according to a second embodiment of the present invention;

FIG. 4 is a block diagram of a DC-to-DC conversion unit according to an embodiment of the present invention;

FIG. 5 is a block diagram of a DC-to-DC conversion control unit according to an embodiment of the present invention;

FIG. 6 is a block diagram of a standby mode control unit according to an embodiment of the present invention; and

FIG. 7 is a diagram showing the timing and output voltage of a resonant conversion control method with a very low standby power consumption of the present invention.

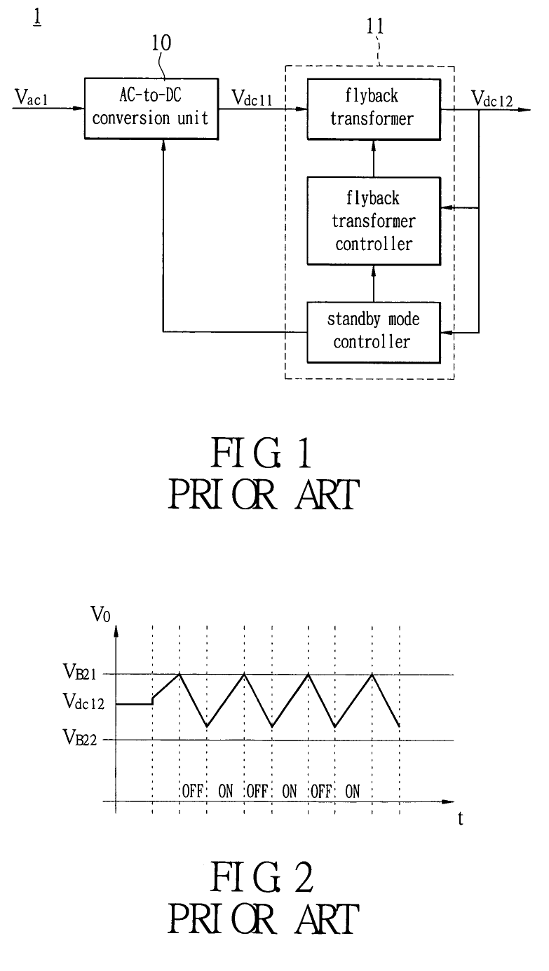

### DETAILED DESCRIPTION OF THE PREFERRED EMBODIMENTS

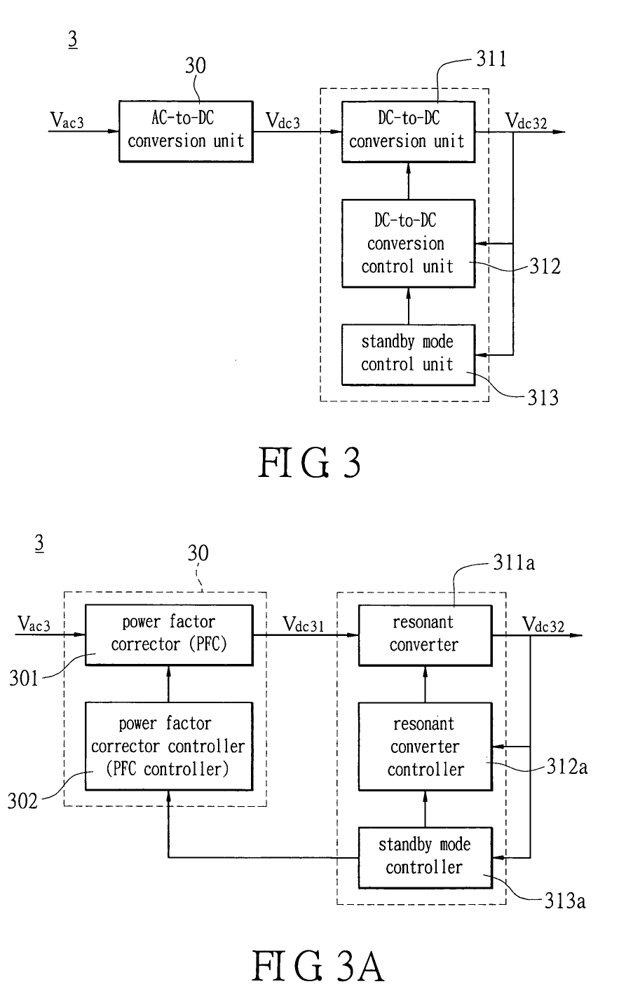

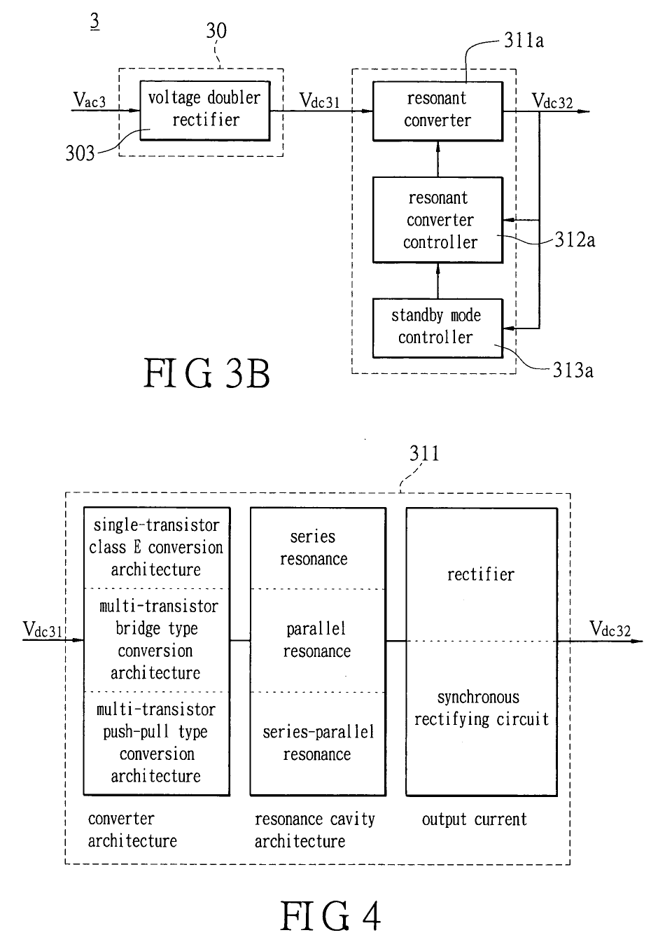

As shown in FIG. 3, a resonant conversion control device 3 with a very low standby power consumption comprises an AC-to-DC conversion unit 30, a DC-to-DC conversion unit 311, a DC-to-DC conversion control unit 312, and a standby mode control unit 313. Depending on the requirement of the system and specification, the AC-to-DC conversion unit 30 can use a power factor corrector (PFC) 301 (as shown in FIG. 3A), or the AC-to-DC conversion unit 30 can use a voltage doubler rectifier 303 (as shown in FIG. 3B). The DC-to-DC conversion unit 311 can be a resonant converter 311a. The DC-to-DC conversion control unit 312 can be a resonant converter controller 312a. The standby mode control unit 313 can be a standby mode controller 313a. In order to meet the requirement for a large load current, a synchronous rectifying circuit can be used in the DC-to-DC converter 311. The PFC 301 or the voltage doubler rectifier 303 is used to perform AC-to-DC power conversion. The voltage doubler rectifier 303 can further comprises a filter. The technological features of the resonant conversion control device 3 with a very low standby power consumption of the present invention will be described in detail below.

After an AC voltage V_{ac3} is sent to the PFC 301 for AC-to-DC power conversion, power factor correction and voltage pre-regulation, or sent to the voltage doubler rectifier 303 for rectification and filtering, a first DC voltage V_{dc3} is output. The DC-to-DC conversion unit 311 receives the first DC voltage V_{dc31} output by the PFC 301 and converts it to a required second DC voltage V_{dc32}. The DC-to-DC conversion control unit 312 adjusts the frequency of a control signal of a power transistor of the DC-to-DC conversion unit 311 to stably output the second DC voltage V_{dc32}. When the DC-to-DC conversion unit 311 uses a synchronous rectifying circuit, the DC-to-DC conversion control unit 312 also needs to provide a control signal of a synchronous rectifying power transistor. After the standby mode control unit 313 receives the second DC voltage output by the DC-to-DC conversion unit 311 and determines the present load situation, it respectively outputs a control signal fed back to a PFC controller 302 and the DC-to-DC conversion control unit 312 to control circuit actions of the PFC 301 and the DC-to-DC conversion unit 311.

Reference is made to FIG. 4. The DC-to-DC conversion unit 311 can be a resonant converter 311a, whose conversion architecture is a single-transistor class E conversion architecture, a multi-transistor bridge type conversion architecture, or a multi-transistor push-pull type conversion architecture. The resonant circuit architecture of the resonant converter 311a is a series resonance architecture, a parallel resonance architecture, or a series-parallel resonance architecture, depending on the connection method between its resonant components and the load. Additionally, the output current part of the resonant converter 311a is a common rectifier or a synchronous rectifying circuit.

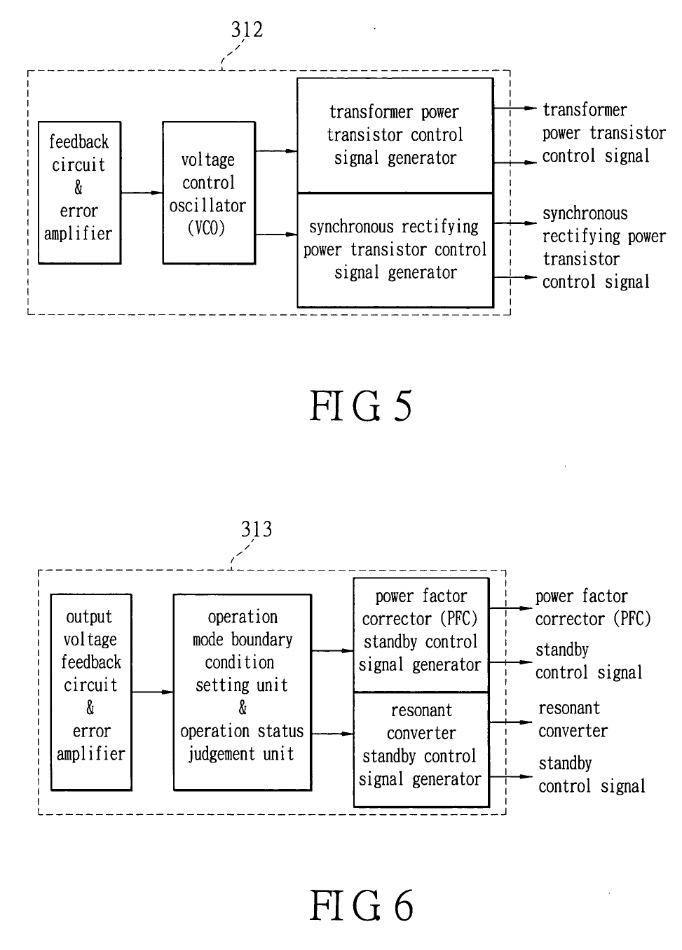

As shown in FIG. 5, the DC-to-DC conversion control unit 312 can be a resonant converter controller 312a. The resonant converter controller 312a is a power transistor control signal generator with a voltage control oscillation (VCO) function, and can receive a feedback voltage control signal to change the frequency of the power transistor control signal.

Reference is made to FIG. 6. The standby mode control unit 313 can be a standby mode controller 313a, which can define the operation state by setting the boundary condition. In other words, when a power supply operates under a light load or no load, a hysteresis comparator (i.e., an operation mode boundary condition setting unit & an operation status judgement unit) in the standby mode control unit 313 is used to generate a trigger signal by means of hysteresis comparison control, thereby controlling the PFC 30 and the DC-to-DC conversion unit 311.

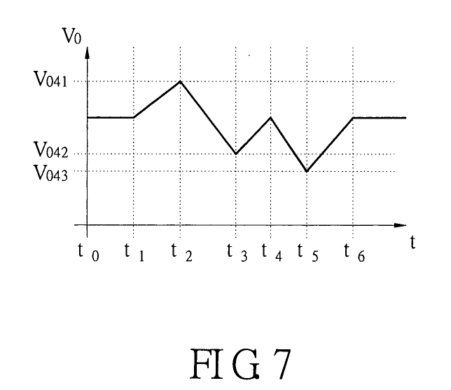

Reference is made to FIG. 7 as well as FIGS. 3 and 3A. The standby mode control unit 313 takes the output voltage for comparison and reference. Three output voltage thresholds (a first threshold V₀₄₁, a second threshold V₀₄₂, and a third threshold V₀₄₃) can be set in the standby mode control unit 313. The three thresholds divide the system operation into four modes, which will be illustrated below in the time domain (the output voltage V₀=V_{dc32}):
t₀<t<t₁ (1)
The system operates under normal conditions. The output can be stably controlled within a certain range, i.e., V₀₄₂<V₀<V₀₄₁. In the meanwhile, both the PFC 301 and the DC-to-DC conversion unit 311 operate normally.
   t₁t<t<t₂ (2)
From the frequency response of the DC-to-DC conversion unit 311, the load current decreases from t=t₁; meanwhile, the output voltage V₀ increases until t=t₂. At t=t₂, V₀ is larger than V₀₄₁, and the standby mode control unit 313 generates a control signal to shut down the PFC 301 and the DC-to-DC conversion unit 311.
   t₂<t<t₃ (3)
At t=t₂, the PFC 301 and the DC-to-DC conversion unit 311 are shut down. From t=t₂, the output voltage V₀ keeps decreasing until t=t₃. At t=t₃, the output voltage V₀ is lower than V₀₄₂, and the operation of the DC-to-DC conversion unit 311 is resumed to increase the output voltage V₀.
   t₃<t<t₄ (4)
At t=t₃, the operation of the DC-to-DC conversion unit 311 is resumed. Under the same load condition, the output voltage V₀ starts increasing until the output voltage V₀ resumes to its normal status. In the meanwhile, the PFC 301 is still disabled, and the DC-to-DC conversion unit 311 enters a standby mode to stabilize the output voltage through burst mode control.
   t₄<t<t₅ (5)
At t=t₄, the load current increases abruptly to cause a fast drop of the output voltage. Even if the DC-to-DC conversion unit 311 still functions, the output voltage cannot be stably kept. At t=t₅, the output voltage V₀ drops to V₀₄₃.
   t₅<t<t₆ (6)
At t=t₅, the output voltage V₀ drops to V₀₄₃, and the standby mode control unit 313 sends out a signal to restart the PFC 301 and the DC-to-DC conversion unit 311 so as to resume the output voltage V₀ back to the normal voltage range.

In the present invention, it is only necessary to adopt an appropriate parameter design of power stage circuit to accomplish zero-voltage switching even under a light load or no load condition. Moreover, an extra snubber is not required. A very low standby power consumption can thus be accomplished even under no load condition.

To sum up, the present invention proposes a resonant conversion control method and device with a very low standby power consumption. A DC-to-DC conversion unit 311 with zero-voltage switching under a light load or no load condition is used to effectively reduce the switching loss under normal operations. Besides, by making use of hysteresis comparison of the output voltage and threshold voltages to perform the burst mode function, the PFC 301 and the DC-to-DC conversion unit 311 are shut down under different output voltage conditions to effectively reduce the standby power consumption.

Furthermore, an extra snubber is not required in the present invention. Under a light load and no load condition, because the system switches at high frequencies, the core power loss is much smaller than that in the prior art. The system power consumption in the standby mode can thus be reduced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A resonant conversion control device with a very low standby power consumption comprising:
an AC-to-DC conversion unit used for AC-to-DC power conversion, power factor correction and pre-regulation to output a first DC voltage;
a DC-to-DC conversion unit and a DC-to-DC conversion control unit, said DC-to-DC conversion unit receiving said first DC voltage from said AC-to-DC conversion unit and used to convert said first DC voltage to a second DC voltage, and said DC-to-DC conversion control unit receiving a feedback signal of said second DC voltage from said DC-to-DC conversion unit to output said stable second DC voltage by adjusting a frequency of a power transistor control signal of said DC-to-DC conversion unit; and
a standby mode control unit for receiving said second DC voltage from said DC-to-DC conversion unit and then outputting a control signal fed back to said AC-to-DC conversion unit and said DC-to-DC conversion unit to control circuit action statuses of said AC-to-DC conversion unit and said DC-to-DC conversion unit;
whereby said second DC voltage is obtained when an AC voltage is input to said resonant conversion control device with a very low standby power consumption, and power consumption is effectively lowered under any load conditions.

2. The resonant conversion control device with a very low standby power consumption as claimed in claim 1, wherein said AC-to-DC conversion unit is a power factor corrector or a voltage doubler rectifier.

3. The resonant conversion control device with a very low standby power consumption as claimed in claim 2, wherein said AC-to-DC conversion unit further comprises a power factor corrector controller electrically connected to said power factor corrector.

4. The resonant conversion control device with a very low standby power consumption as claimed in claim 2, wherein said voltage doubler rectifier further comprises a filter.

5. The resonant conversion control device with a very low standby power consumption as claimed in claim 1, wherein said DC-to-DC conversion unit is a resonant converter.

6. The resonant conversion control device with a very low standby power consumption as claimed in claim 1, wherein said DC-to-DC conversion control unit is a resonant converter controller.

7. The resonant conversion control device with a very low standby power consumption as claimed in claim 5, wherein the conversion architecture of said resonant converter is a single-transistor class E conversion architecture, a multi-transistor bridge type conversion architecture, or a multi-transistor push-pull type conversion architecture.

8. The resonant conversion control device with a very low standby power consumption as claimed in claim 5, wherein the resonant circuit architecture of said resonant converter is a series resonance architecture, a parallel resonance architecture, or a series-parallel resonance architecture.

9. The resonant conversion control device with a very low standby power consumption as claimed in claim 5, wherein the output rectification architecture of said resonant converter is a rectifier or a synchronous rectifying circuit.

10. The resonant conversion control device with a very low standby power consumption as claimed in claim 6, wherein said resonant converter controller further comprises a voltage control oscillator.

11. The resonant conversion control device with a very low standby power consumption as claimed in claim 1, wherein said standby mode control unit comprises a hysteresis comparator.

12. A resonant conversion control method with a very low standby power consumption used to judge the present system load status by detecting an output voltage and setting at least two voltage thresholds, the method comprising:
(a) judging the voltage level of said output voltage; and
(b) operating or closing an AC-to-DC conversion unit and a DC-to-DC conversion unit.

13. The resonant conversion control method with a very low standby power consumption as claimed in claim 12, wherein a first voltage threshold, a second voltage threshold and a third voltage threshold are set, said first voltage threshold is larger than said second voltage threshold, and said second voltage threshold is larger than said third voltage threshold.

14. The resonant conversion control method with a very low standby power consumption as claimed in claim 13, wherein said AC-to-DC conversion unit and a DC-to-DC conversion unit operate in said step (b) if the voltage level of said output voltage is judged to be between said first voltage threshold and said second voltage threshold in said step (a).

15. The resonant conversion control method with a very low standby power consumption as claimed in claim 13, wherein said AC-to-DC conversion unit and a DC-to-DC conversion unit operate in said step (b) if the voltage level of said output voltage is judged to be smaller than said third voltage threshold in said step (a).

16. The resonant conversion control method with a very low standby power consumption as claimed in claim 13, further comprising the following steps if the voltage level of said output voltage is judged to be larger than said first voltage threshold in said step (a):
(c) closing said AC-to-DC conversion unit and said DC-to-DC conversion unit;
(d) judging whether the voltage level of said output voltage is smaller than said second voltage threshold; and
(e) closing said AC-to-DC conversion unit and operating said DC-to-DC conversion unit.

17. The resonant conversion control method with a very low standby power consumption as claimed in claim 16, further comprising the following steps after said step (e):
(f) judging whether the voltage level of said output voltage is smaller than said third voltage threshold; and
(g) operating said AC-to-DC conversion unit and said DC-to-DC conversion unit.

18. The resonant conversion control method with a very low standby power consumption as claimed in claim 12, wherein the method is a repetitive circulation.

19. The resonant conversion control method with a very low standby power consumption as claimed in claim 13, wherein the method is a repetitive circulation.
